(19) United States
(12) Patent Application Publication
(10) Pub. No.: US 2010/0178627 A1
(43) Pub. Date: Jul. 15, 2010

(54) AUTOMATIC FEED OVEN

(75) Inventors: Bruce J. Dover, Lockport, NY (US); Jason A. Gwin, Corfu, NY (US)

Correspondence Address: PHILLIPS LYTLE LLP;INTELLECTUAL PROPERTY GROUP, 3400 HSBC CENTER, BUFFALO, NY, 14203-3509, US

(73) Assignee: HARPER INTERNATIONAL CORPORATION, Lancaster, NY (US)

(21) Appl. No.: 12/684,667

(22) Filed: Jan. 8, 2010

Related U.S. Application Data
(60) Provisional application No. 61/204,723, filed on Jan. 9, 2009.

(51) Int. Cl. F27D 3/00

(52) U.S. Cl. 432/87

(57) ABSTRACT

An automatic feed oven for material processing (1) comprising an insulated heating chamber (4), the heating chamber having the product discharge outlet (21) and a material inlet (39), a heating source (14) operatively arranged to heat the heating chamber, a chamber feed mechanism (40) operatively arranged to feed material into the chamber through the material inlet, the chamber feed mechanism comprising a receptacle (6) operatively arranged to receive material, a linear actuator (42) operatively arranged to move the receptacle between a fill position (55) outside the chamber and a discharge position (56) within the chamber, a rotational actuator (43) operatively arranged to rotate the receptacle between a receiving position (57) and a releasing position (58), and a receptacle feed mechanism (44) operatively arranged to feed material into the receptacle when the receptacle is in the fill position.

### CROSS-REFERENCE TO RELATED APPLICATIONS

This application claims the benefit of U.S. Provisional Patent Application No. 61/204,723, filed Jan. 9, 2009. The entire content of such application is incorporated by reference herein.

### TECHNICAL FIELD

The present invention relates to furnaces for high temperature treatment of various materials and, more particularly, to an automatic feed oven.

### BACKGROUND ART

A number of automatic feeds for ovens are known in the prior art. For example, ovens with a screw feeder are known to allow for the transportation of material into the oven. These types of ovens are provided with a rotating screw that has a pitch that moves material in a given direction with rotation of the screw. Another type of feeder system known is a vibratory feeder system. In these types of systems, the feed mechanism is vibrated at a particular frequency to move the material down a gradient. These types of conveyors or feeders depend on the flowability of the material being conveyed.

### DISCLOSURE OF THE INVENTION

With parenthetical reference to corresponding parts, portions or surfaces of the disclosed embodiment, merely for the purposes of illustration and not by way of limitation, the present invention provides an automatic feed oven for material processing (1) comprising an insulated heating chamber (4), the heating chamber having a product discharge outlet (21) and a material inlet (39), a heating source (14) operatively arranged to heat the heating chamber, a chamber feed mechanism (40) operatively arranged to feed material into the chamber through the material inlet, the chamber feed mechanism comprising a receptacle (6) operatively arranged to receive material, a linear actuator (42) operatively arranged to move the receptacle between a fill position (55) outside the chamber and a discharge position (56) within the chamber, and a rotational actuator (43) operatively arranged to rotate the receptacle between a receiving position (57) and a releasing position (58), and a receptacle feed mechanism (44) operatively arranged to feed material into the receptacle when the receptacle is in the fill position.

The heat source may be operatively arranged to selectively heat the heating chamber to at least 600° C. The heating chamber and the chamber feed mechanism may be within an internal atmosphere isolated from an external ambient atmosphere. The fill position and the discharge position may be at least two feet apart. The receiving position and the releasing position may be between about 90° and about 180° apart. The oven may further comprise a spill access port (45) for removal of material spilled between the receptacle and the receptacle feed mechanism. The oven may further comprise a cooling apparatus (46) configured to cool the receptacle.

The receptacle feed mechanism may comprise a screw or vibratory conveyor (7) having an inlet (61) and an outlet (62), a hopper (12) having an outlet in communication with the inlet of the screw or vibratory conveyor, and the outlet of the screw or vibratory conveyor operatively configured to feed material into the receptacle when the receptacle is in the fill position. The receptacle feed mechanism may further comprise a metering control communicating with the conveyor and configured to activate the conveyor when the receptacle is in the fill position and to deactivate the conveyor when the receptacle is not in the fill position.

The receptacle feed mechanism may comprise a funnel (63) having a discharge port (64) and a stopper (65) configured to move from an open position (66) to a closed position (67), wherein the discharge port is substantially blocked by the stopper when the stopper is in the closed position. The receptacle feed mechanism may comprise a metering control configured to provide the stopper in the open position when the receptacle is in the fill position and to provide the stopper in the closed position when the receptacle is not in the fill position, and the metering control may comprise a mechanical trigger.

The oven may further comprise a generally horizontally extending process tube (2) supported for rotation relative to the heating chamber, the process tube having a portion (37) extending into the heating chamber, and the feed mechanism may be configured and arranged to feed product into the process tube. The oven may further comprise a generally horizontally extending process tube supported for rotation relative to the heating chamber, the process tube having a first portion (36) generally arranged outside of the heating chamber and a cantilevered second portion (37) extending from the first portion into the heating chamber and terminating in a discharge end (38) within the heating chamber, the feed mechanism configured and arranged to feed product into the process tube, and a bearing assembly 41 operating between a support member (34) and the first portion of the process tube and configured and arranged to support the process tube and transmit rotational torque to the process tube.

The heating chamber may comprise an outer shell (10), a muffle (15) and an insulation layer (11) between the outer shell and the muffle. The heating element may be a graphite resistance heating element. The heating element may comprise induction coils (30) and a graphite susceptor (31). The heating element may be an exothermic reaction within the heating chamber. The process tube may be graphite or quartz. The chamber feed mechanism may extend through the first portion of the process tube and terminate at a feed discharge position within the heating chamber. The product discharge outlet may comprise a discharge chute (22) and a discharge heating element (25) operatively arranged to selectively heat the discharge shut.

In another aspect, the invention provides an automatic feed oven system for material processing comprising an insulated heating chamber, the heating chamber having a product discharge outlet and a material inlet, a heat source operatively arranged to heat the heating chamber, a chamber discharge operatively arranged to remove product from the chamber through the discharge outlet, a chamber feed mechanism operatively arranged to feed material into the chamber through the material inlet, the chamber feed mechanism comprising a receptacle operatively configured to receive material, a linear actuator operatively arranged to move the receptacle between a fill position outside the chamber and a discharge position within the chamber, and a scrapper operatively arranged to dislodge the material from the receptacle when the receptacle is in the discharge position, and a receptacle feed mechanism operatively arranged to feed material into the receptacle when the receptacle is in the fill position. The scrapper may comprise a linear actuator (105) connected to a member (106) operatively arranged to dislodge material from said receptacle.

One object of the invention is to provide an improved furnace that provides the materials being processed without premature melting.

Another object is to provide an improved furnace that processes materials at high temperatures without the material adhering to the processing equipment.

Another object is to provide an improved furnace where material flow is not blocked by undesired material build-up.

These and other objects and advantages will become apparent from the foregoing and ongoing written specification, the drawings, and the claims.

### BRIEF DESCRIPTION OF THE DRAWINGS

FIG. 1 is a sectional view of a first embodiment of the automatic feed furnace of the present invention with the feed spoon at the fill and receive position.

FIG. 2 is a sectional view of the automatic feed furnace shown in FIG. 1 with the feed spoon at the discharge and release position.

FIG. 3 is a partial transverse vertical sectional view of the embodiment shown in FIG. 1, taken generally on line 3-3 of FIG. 1.

FIG. 4 is a partial longitudinal vertical sectional view of the embodiment shown in FIG. 1, taken generally on line 4-4 of FIG. 3.

FIG. 5 is a partial perspective view of the actuating mechanism shown in FIG. 1.

FIG. 6 is a partial perspective view of the actuating mechanism shown in FIG. 2.

FIG. 7 is a sectional view of a second embodiment of the automatic feed furnace shown in FIG. 1.

FIG. 8 is a sectional view of the automatic feed furnace shown in FIG. 7 with the feed spoon at the discharge and release position.

FIG. 9 is a sectional view of a third embodiment of the automatic feed furnace shown in FIG. 8.

FIG. 10 is a sectional view of the third embodiment of the automatic feed furnace shown in FIG. 8 with an alternate release.

### DESCRIPTION OF PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

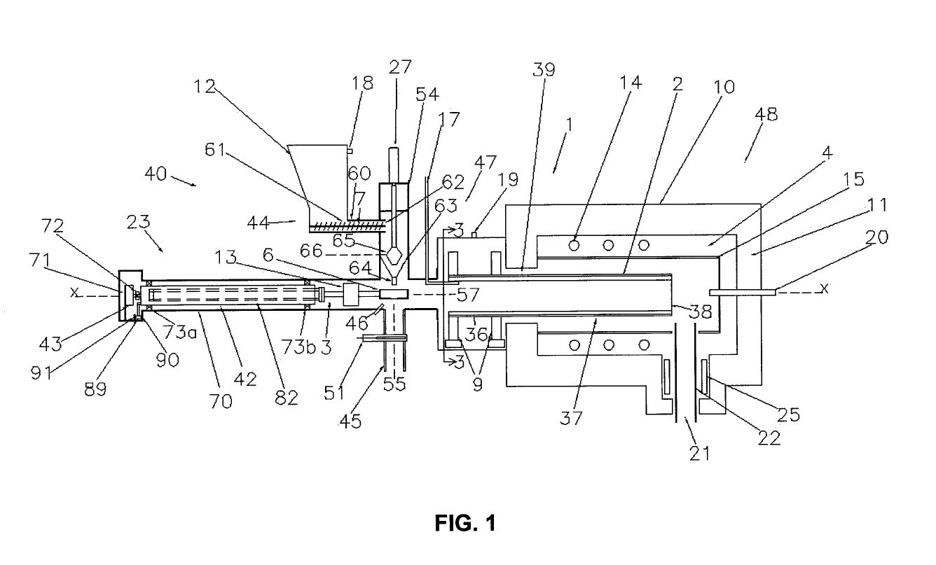

Referring now to the drawings, and more particularly to FIG. 1 thereof, this invention provides an improved automatic feed oven, of which a first embodiment is generally indicated at 1. As shown, furnace 1 generally includes an insulated heating chamber 4, heating elements 14 operatively arranged to selectively heat heating chamber 4, a horizontally-extending graphite process tube 2 elongated along axis x-x and supported for rotation about axis x-x, a feed mechanism 40 configured and arranged to feed product into process tube 2, and a bearing assembly 41 operating between a support frame 34 and process tube 2 that supports process tube 2 and transmits rotational torque to process tube 2.

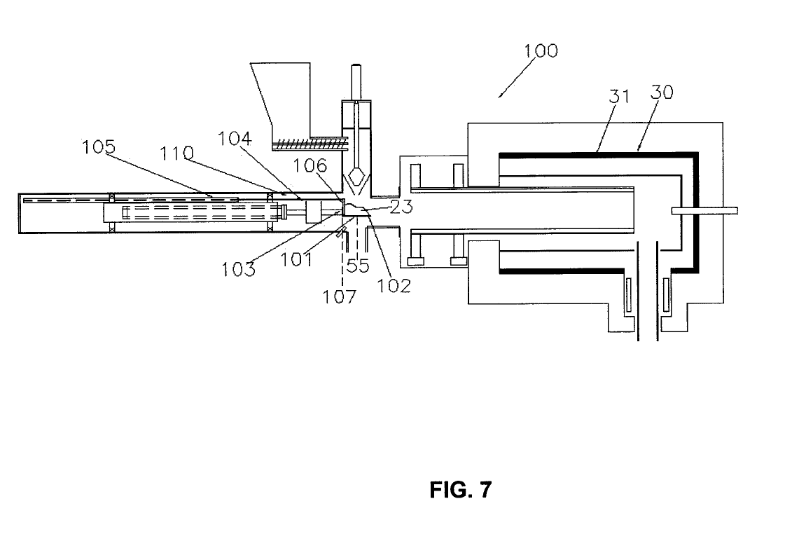

As shown in FIG. 1, furnace 1 is divided into a heating section 48 and a drive or entrance section 47. Heating section 48 of furnace 1 comprises a heating chamber 4 within an insulation enclosurer 11, which in turn is enclosed in metal shell 10, which may be of a suitable heat resistant material, such as stainless steel. In the preferred embodiment, insulation 11 is high temperature insulation, such as formed carbon fiber or other suitable fibrous insulation. Heating chamber 4 contains one or more conventional heating elements 14 adapted to selectively heat chamber 4. In the embodiment shown in FIG. 1, heating elements 14 are graphite resistance heating elements. However, it is contemplated that other heating methods may be employed. For example, as shown in FIG. 7, graphite tube 2 may be inductively heated using conventional induction coils 30 and graphite susceptor 31. Heating chamber 4 also contains a highly conductive graphite muffle 15, which separates the area in which material is discharged from process tube 2 from heating elements 14. This separation of heating elements 14 and the process area allows heating elements 14 to be purged with clean non-oxidizing gas.

Thermally insulated heating chamber 4 surrounds the portion of tube 2 being heated with at least one zone of control and at least one element per zone of control. However, while furnace 1 is shown as having a single heating zone, heating chamber 4 may be divided into multiple temperature zones separated by insulation barriers to allow for greater temperature definition. Thus, heating elements 14 may be powered and positioned as desired to provide a constant temperature throughout the heating zone or to provide multiple temperature zones for thermal profiling.

Heating chamber 4 includes a number of ports or vents. Material being processed exits the floor of heating chamber 4 through discharge outlet 21. Discharge outlet 21 comprises a discharge chute 22 and chute heating elements 25 that heat discharge chute 22. A liner may be provided in discharge chute 22 to facilitate movement of material being processed. Accordingly, discharge chute 22 is separately heated to prevent melted material exiting process tube 2 from prematurely cooling and sticking to discharge chute 22. Discharge chute 22 may feed a solidification unit or some other conventional collection device.

Process tube 2 extends into heating chamber 4 through heating chamber inlet 39. Process tube 2 is generally a cylindrical graphite member elongated along axis x-x and adapted to rotate about axis x-x. As shown, process tube 2 extends from the entrance or drive section 47 of furnace 1 into heating chamber 4 of the heating section 48 of furnace 1. While shown as extending horizontally, under normal operating conditions process tube 2 is tilted from horizontal to aid the movement of materials through process tube 2. In addition, while process tube 2 is shown as being formed of a single tubular unit, it may be formed from two or more interconnected sections of tube, depending on various considerations, such as the total length required and the specific requirements of each section of the tube. Also, the materials used to form the sections of tube may vary depending on their position in the furnace, with the sections of tube 2 upstream being metal rather than graphite sections. In this embodiment, tube 2 includes an inner quartz tube liner. However, it is contemplated that this inner or second tube may be formed of graphite or ceramic, such as silicon carbide, alumina or mullite, depending on considerations such as the materials being processed. The liner may also be a second piece of sacrificial graphite. In another alternative, tube 2 may be quartz and may not include a liner.

As shown in FIG. 1, feed mechanism 40 is provided to deliver material or product 23 to process tube 2. In this first embodiment, feed mechanism 40 generally comprises rotational actuator 43, linear actuator 42 connected to spoon 6, and secondary feed mechanism 44 for feeding material to spoon 6.

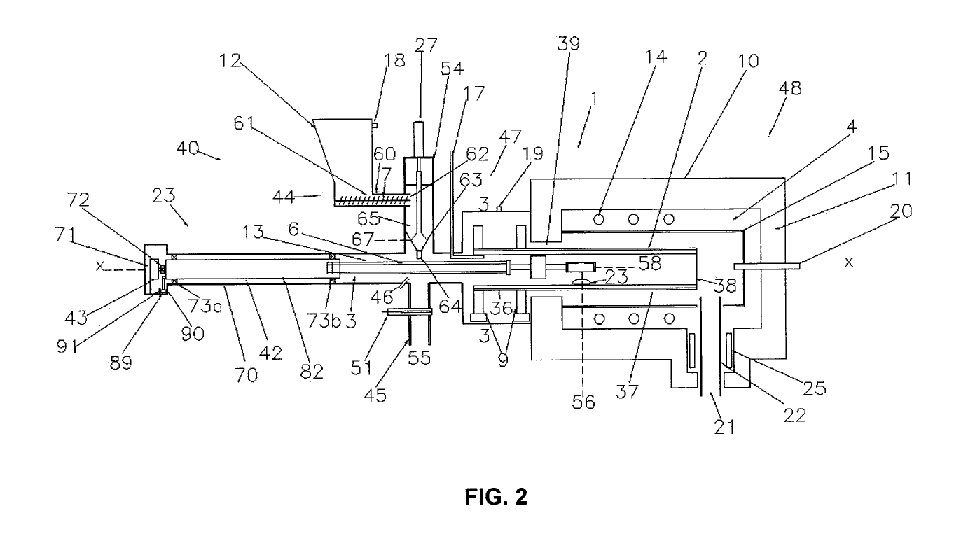

Feed mechanism 44 is operatively arranged to feed material into spoon 6 when spoon 6 is in fill position 55 and receiving position 57, and generally comprises a large upstream feed hopper 12, a smaller downstream funnel-shaped hopper 63 that narrows and discharges from discharge port 64 into spoon 6 when spoon 6 is in fill position 55 and receiving position 57, and a screw conveyor 7 operating between upstream hopper 12 and funnel 63. Conical or dish-shaped stopper 65 is employed to control the discharge of material from discharge port 64. Pneumatic actuator 27 moves stopper 65 vertically from open position 66 shown in FIG. 1 to closed position 67 shown in FIG. 2, such that discharge port 64 is open when spoon 6 is in fill position 55 and receiving position 57 and is closed when spoon 6 is not in such positions.

Alternative designs for discharge port 64 may be employed. For example, discharge port 64 may be a rectangular slot with the long axis of the slot parallel to axis x-x of tube 2. Whether the slot is open or closed may be controlled with a hinged door either parallel or perpendicular to axis x-x.

The position of stopper 65 is a function of the position of receptacle 6, such that the return of spoon 6 from position 56 to linear position 55 and rotational position 57 causes actuator 27 to move stopper 65 to open position 66, opening port 64 and emptying material into spoon 6. The overall average rate of material fed into spoon 6 is controlled by the rate of conveyance of screw conveyor 7. The cycle time of spoon 6 extending to discharge position 56, dumping by rotation to release position 58, rotating back to receive position 57 and returning to fill position 55 is short enough so that receptacle 6 is not over-filled by material accumulated in downstream funnel hopper 63. The cycle time for spoon 6, the speed of screw conveyor 7 and the periodic rate at which stopper 65 moves between position 66 and 67 may be coordinated such that material only exits discharge 64 into spoon 6 when spoon 6 is in positions 55 and 57 and in amounts such that spoon 6 does not overflow.

Alternatively, the movement of stopper 65 and spoon 6 may be controlled by sensors and programmable logic controllers or hardwired relays. In this alternative, proximity switches are positioned relative to the three actuators 27, 42 and 43 to sense the location of spoon 6 and stopper 65. Using these proximity switches, the system first confirms that rotational actuator 43 is in the feed position, at which spoon 6 is in receiving position 57, confirms that linear actuator 42 is in the retracted position, at which spoon 6 is in fill position 55, confirms that screw feeder 7 is off, and confirms that actuator 27 is in the closed position, at which stopper 65 is in closed position 67. Actuator 27 then elevates stopper 65 to open position 66, releasing material from discharge port 64 into spoon 6. Actuator 27 then lowers stopper 65 to closed position 67. Linear actuator 42 then extends rods 85/3 and spoon 6 to discharge position 56. This position is confirmed by proximity switch. Rotational actuator 43 then rotates actuator 42 and spoon 6 between 90° and 180° to release position 58, releasing material from spoon 6 onto process tube 2 in heating chamber 4. This is confirmed by proximity switch. Rotational actuator 43 then rotates linear actuator 42 and spoon 6 back to receiving position 57. This is confirmed by proximity switch. Linear actuator 42 then retracts rods 85/3 and spoon 6 from heating chamber 4 to fill position 55. This is confirmed by proximity switch. Screw feeder 7 is then activated for a predetermined period of time, feeding a selected amount of material from hopper 12 into funnel 63. Screw 7 is then deactivated. The above sequence is then repeated.

Thus, in this embodiment, material is feed into hopper 12, where it discharges through inlet 61 of horizontally extending feeder tube 60, which houses screw conveyor 7. While in this embodiment feeder 7 is a screw type feeder, other types of feeders may be used, such as vibratory or pneumatic type feeders. With a vibratory feeder, flexible bellows are positioned so that feeder tube motion, such as vibration, will not hinder flow and an adequate seal is provided for gas containment purposes. Tube 60 extends through a port into fill tube 54 and outlet 62 of tube 60 is positioned above cylindrical funnel 63 such that material conveyed through outlet 62 falls into funnel 63. Stopper 65 is moved by actuator 27 from its closed position 67 blocking discharge port 64 to its open position 66, allowing material to flow out of discharge port 64 and into spoon 6.

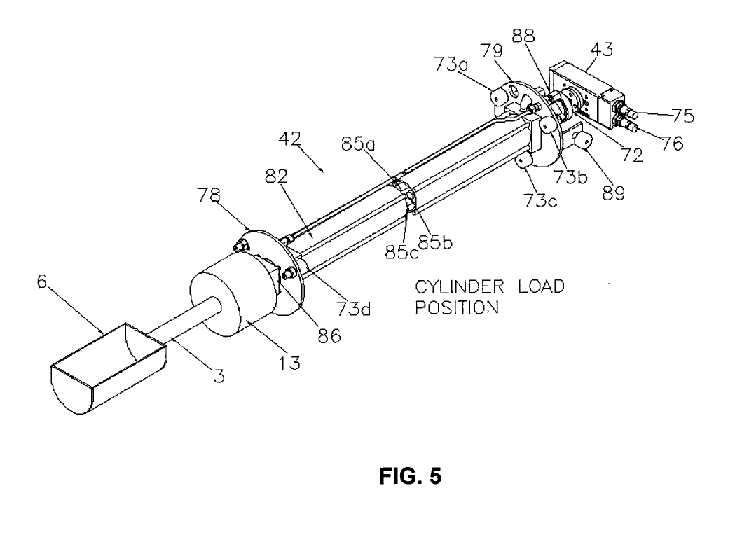

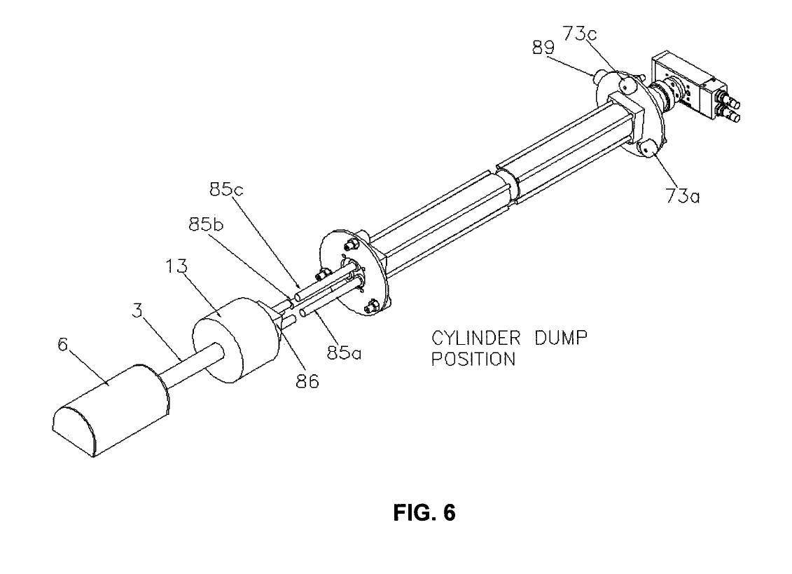

As shown in FIGS. 5 and 6, actuating mechanism 40 includes a rotational actuator 43 connected to linear actuator 42 housed in containment tube 70. The right end of tube 70 has an open end communicating with the open end of process tube 2 and inlet 39 of chamber 4.

Rotational actuator 43 is a pneumatic actuator that converts compressed air or gas from ports 75 and 76 into rotational motion about axis x-x. Rotational actuator 43 is fixably supported in tube 70 by support plate 71. Rotational actuator 43 is configured to cycle linear actuator 42 back and forth between about 0° and 180° degrees as desired.

Linear actuator 42 is connected for rotation by coupling 72 to rotational actuator 43. Linear actuator 42 is a pneumatic cylindrical actuator adapted to actuate spoon 6 from receiving position 57 shown in FIG. 1 to releasing position 58 shown in FIG. 2. As shown, linear actuator 42 generally comprises a front annular bearing plate 78, a rear annular bearing plate 79 and a triple rod-supported cylinder 82 extending between front plate 78 and rear plate 79. As shown, each of rear and front plates 78 and 79 include three rolling bearings 73 spaced along their outer circumference. Rollers 73 bear against the inner cylindrical surface of tube 70 to support rotational movement of linear actuator 42 about axis x-x in tube 70 from 0° to between 90 and 180 degrees. A piston in slidable engagement with the inner cylindrical surface of cylinder 82 is connected to three rods 85a-c. The other ends of rods 85a-c are connected at block 86 to one end of rod 3. The other end of rod 3 is in turn connected to spoon 6. Gas port 88 is provided in cylinder 82 for pneumatically controlling the position of the piston in cylinder 82 along axis x-x and thereby pneumatically controlling the position of spoon 6 along axis x-x. When spoon 6 is in releasing position 58, rods 85/3 and spoon 6 are cantilevered out beyond plate 78. As shown in FIGS. 5 and 6, a thrust or lateral restraint bearing 89 is provided to restrain plates 78 and 79 from moving laterally along axis x-x in tube 70 with actuation of spoon 6. Restraint 89 bears against leftwardly-facing vertical annular surface 90 of tube 70 and opposed annular bearing plate 91.

Accordingly, rotational actuator 43 is configured to move spoon 6 from receiving position 57, in which material may be dropped into and retained within spoon 6, to releasing position 58, which is a rotational position from 90° to 180° about axis x-x from receiving position 57. Linear actuator 42 is adapted to move spoon 6 from fill position 55 directly below discharge port 64 to discharge position 56 within heating chamber 4. In this embodiment, actuator 42 is configured to have a stroke of between about 2 and 6 feet and preferably a stroke of about 4 feet. Thus, fill position 55 and discharge position 56 may be more than two feet apart in this embodiment.

As shown in FIG. 1, containment tube 70 communicates with fill tube 54, which houses funnel 63 and stopper 65. Tube 70 also includes spill or clean-out port 45 to allow routine removal of material that overflows or misses spoon 6 during the filling of spoon 6. Thus, material spilled between spoon 6 and discharge port 64 may be collected and easily removed. As shown, spill port isolation valve 51 is provided in order to preserve the internal atmosphere of oven 1.

Tube 70 also includes cooling vent 46 for cooling spoon 6 and, if desired, rod 3 to the extent that rod 3 passes by the outlet of cooling vent 46. Thus, where the temperature of spoon 6 is likely to be exceedingly high, cooling vent 46 is used to cool spoon 6 when it is in or near fill position 55. In this embodiment, cooling vent 46 comprises a gas jet that provides an impinging cooled gas stream against the surface of spoon 6 such that the outer convex surface of spoon 6 is cooled when spoon 6 is in fill position 55 and receiving position 57. In addition, the inner concave surface of spoon 6 may be cooled by rotating spoon 6 to releasing position 58 when spoon 6 is still in fill position 55 near gas cooling vent 46. Thus, spoon 6 is periodically cooled when it is retracted from heating chamber 4.

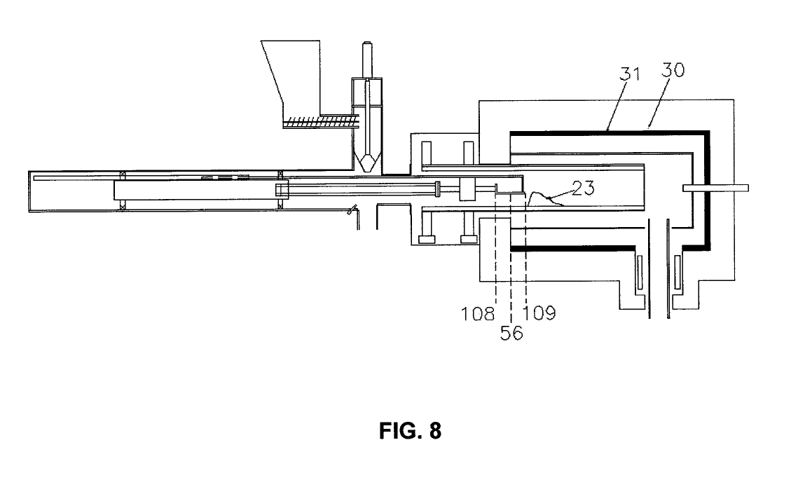

The length of rod 3 may vary as desired. As shown in FIG. 8, spoon 6 may extend into portion 37 of process tube 2 and terminate just beyond inlet 39 of heating chamber 4. In this embodiment, an insulating baffle 13 is provided on rod 3 between the outer cylindrical surface of rod 3 and the inner cylindrical surface of process tube 2. In other embodiments, rod 3 may extend further into heating chamber 4 than the embodiment shown in FIG. 2. Thus, material may be fed directly into the heated part of process tube 2.

As shown in FIG. 1, process tube 2 is supported from its entrance end and has a cantilevered portion 37 that extends freely through inlet 39 into heating chamber 4. Thus, heating tube 2 has a first portion 36 generally arranged outside of heating chamber 4 and a cantilevered second portion 37 extending from the first portion through inlet 39 into heating chamber 4 and terminating at a discharge end 38 within heating chamber 4.

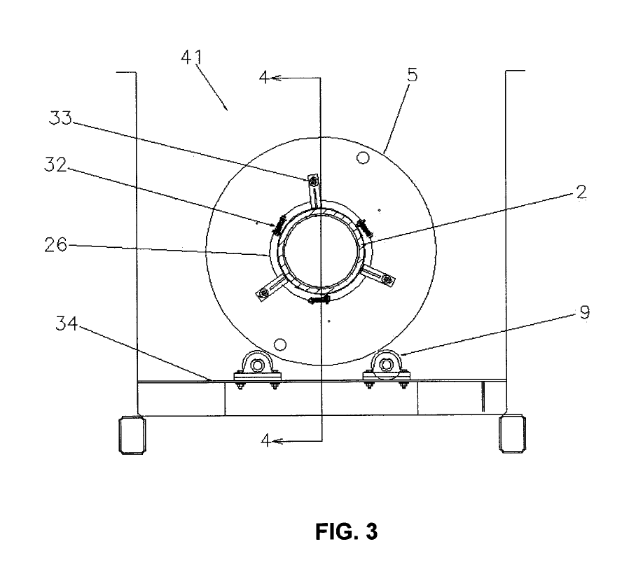

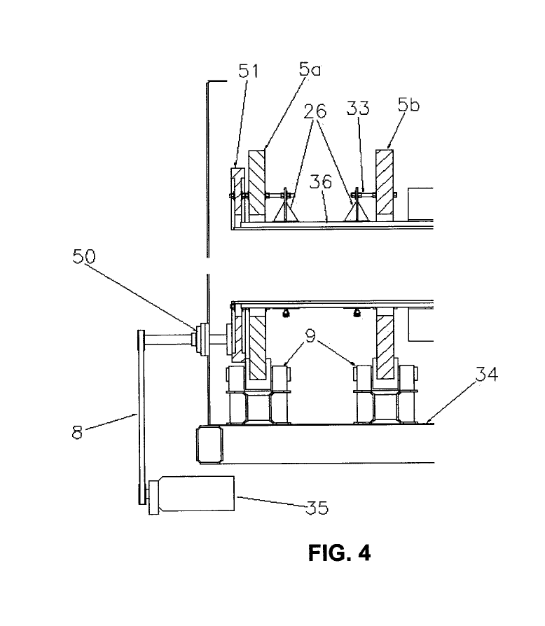

As shown in FIGS. 3 and 4, process tube 2 is supported in its cantilevered orientation and rotated with bearing assembly 41. In this embodiment, bearing assembly 41 comprises motor 35 connected to sprocket 50 with drive chain assembly 8. Sprocket 50 is in turn connected to metal tire 5a. Tires 5 are each connected to process tube 2 with flexible collars 26, which maintain a frictional grip on the outer surface of first portion 36 of process tube 2 while taking up any thermal expansion differences between process tube 2 and collar 26. The flexibility in collar 26 is provided by means of multiple springs 32 acting between sections of cylindrical collar 26. In this embodiment, collar 26 is connected to tire 5 by connecting rod 33. Thus, drive motor 35 and assembly 8 rotate sprocket 50, and in turn tire 5a. Rotation of tire 5a about axis x-x causes rotation of collar 26 and, in turn, rotation of process tube 2 about axis x-x.

As shown on FIG. 3, two steel trunnion rollers 9 connected to frame 34 rotationally support each metal tire 5. Tire 5a closest to feeder 7 is weighted sufficiently to counter the weight of the overhung or cantilevered portion 37 of tube 2. The weight of tire 5a is sufficient not only to counter cantilevered portion 37 of process tube 2, but also any additional weight arising from liner 3 or other equipment on process tube 2. Rollers 9 supporting tire 5b are positioned at the fulcrum point between the first portion 36 and the cantilevered portion 37 of process tube 2. The weight of tires 5 and associated connectors is such that the center of gravity of process tube 2 along axis x-x is located between tires 5a and 5b. Thus, process tube 2 does not tip off the rollers. A locating roller may also be positioned on drive tire 5a to help maintain the position of tube 2a horizontally along axis x-x. While a twin tire bearing assembly 41 has been described in this embodiment, it is contemplated that other bearing or drive assemblies may be employed. Also, if the size of the tube warrants, a bearing on the top of tire 5a may be added to counter some of the tipping force. In this alternative, some but not all of the tipping force is countered by the weight of tires 5 and associated connectors and the remainder of the force is countered by the bearing on the top of tire 5a.

In operation at high temperatures, it is often preferred to maintain a non-oxidizing atmosphere, such as nitrogen or argon gas atmosphere, in heating chamber 4 and process tube 2. In this embodiment, entrance zone 47 is enclosed in, or surrounded by, a chamber for the containment of atmosphere, dust and light. Heating chamber 4, this entrance area, discharge assembly 21, tube 70, tube 54 and port 55 are configured to form an enclosure to maintain the selected atmosphere around and within process tube 2. The interior atmosphere of process tube 2 may be controlled by passing a non-oxidizing gas, such as nitrogen for example, through it. If a co-current gas flow is desired, gas is provided through port 17 and exits heating chamber 4 through process vent 20. If counter flow is desired, the direction of flow can be reversed. A counter flow of non-oxidizing gas in discharge chute 22 may also be provided. Furthermore, a non-oxidizing atmosphere may be provided in heating chamber 4 by maintaining a positive pressure of gas through heating chamber 4 using gas passageways into heating chamber 4. In addition, a desired atmosphere may be provided in feed mechanism 44 using inlet 18 in hopper 12. Similarly, a desired atmosphere in entrance or drive section 47 may be provided directly through drive area gas port 19. Thus, multiple alternate atmospheres and alternate current flows may be employed in furnace 1.

Overhung graphite rotary tube furnace 1 may be used to process various types of feed material, including particulate material. For example, furnace 1 may be used to process silicon particulate material, with the silicon particulate material melting inside quartz or quartz lined process tube 2 and exiting through discharge assembly 21 as a liquid. Furnace 1 is generally suitable for the treatment of particulate material which melts at temperatures as high as 2600° C. The preferred temperature range of furnace 1 is from about 600° C.-2200° C. For silicon processing the preferred temperature is about 1500° C. and the material may be fed directly into the heated and cantilevered section 37 of processing tube 2 to melt.

Furnace 1 provides a number of unexpected benefits. With feed mechanism 40 and cantilevered tube 2, furnace 1 is suitable for partially melting material in a continuous feed system without causing premature melting. In addition, because the material is discharged from discharge end 38 of tube 2 into the hot zone of the furnace, the material is discharged without premature freezing. With feed mechanism 40, the backflow of heat from heating chamber 4 does not melt material being processed, thereby causing it to stick together or to the walls of process tube 2. Likewise, discharging from cantilevered portion 37 in heating chamber 4 reduces the likelihood of material sticking together or to the tube walls or downstream surfaces, thereby blocking material flow.

FIG. 7 shows a second embodiment 100. This embodiment is similar to embodiment 1. However, unlike embodiment 1, a rotational actuator is not needed, and shovel 101 and scrapping assembly 110 are used to deposit material from shovel 101 into tube 2 when shovel 101 is in discharge position 56. Shovel 101 has a generally horizontally extending planar member 102 for receiving material attached at its rear edge to the bottom edge of a vertically extending flange portion 103, which is affixed to the end of rod 3. An additional pneumatic cylindrical linear actuator 105 is provided in tube 70 above linear actuator 42. Actuator 105 moves actuating rod 104 parallel to axis x-x. The other end of rod 104 is affixed to scrapper plate 106 operatively arranged to dislodge any material 23 retained on shovel 101 from it. Thus, the bottom edge of plate 106 rests on the top surface of plate 102 and the width of scrapper 106 is the same or slightly greater than the width of platform 102. FIG. 7 shows scrapper 106 in load position 107, which allows shovel 101 to be filled with material 23. The first step in the operation of this embodiment is to confirm with proximity switches that linear actuator 42 is in the retracted position, at which shovel 101 is in fill position 55, confirm that screw feeder 7 is off, confirm that stopper 65 is in closed position 67, and confirm that actuator 105 is in retracted position 107. Actuator 27 then elevates stopper 65 to open position 66, releasing material 23 from discharge port 64 onto shovel 101. Actuator 27 then lowers stopper 65 to closed position 67. Linear actuator 42 then extends rods 85/3 and shovel 101 to discharge position 56. Both valves on scrapper actuator 105 are open at this stage such that the extension of rods 85/3 and shovel 101 to discharge position 56 results in rod 104 extending from actuator 105 until scrapper 106 is at first extended position 108 without any countering force. The positions of shovel 101 and scrapper 106 are confirmed by proximity switches. Scrapper actuator 105 then extends rod 104 and scrapper 106 out further to fully extended position 109, pushing material 23 from the top of shovel 101 and into process tube 2 in heating chamber 4 as shown in FIG. 8. Scrapper actuator 105 then retracts rod 104 and scrapper 106 until the leftwardly-facing vertical surface of scrapper 106 bumps or rests against the rightwardly-facing vertical surface of plate 103 of shovel 101. The capacity of actuator 105 is such that its retracting force on scrapper 106 is less than the extending force applied by linear actuator 42, whereby the retracting force on scrapper 106 does not cause the retraction of shovel 101. Linear actuator 42 then retracts rods 85/3 and shovel 101 to fill position 55. With this retraction by actuator 42, scrapper actuator 105 is able to similarly retract rod 104 and scrapper 106 to retracted position 107. These positions are confirmed by proximity switch. Screw feeder 7 is then activated for a predetermined period of time, feeding a selected amount of material from hopper 12 into funnel 63. Screw 7 is then deactivated. The sequence is then repeated.

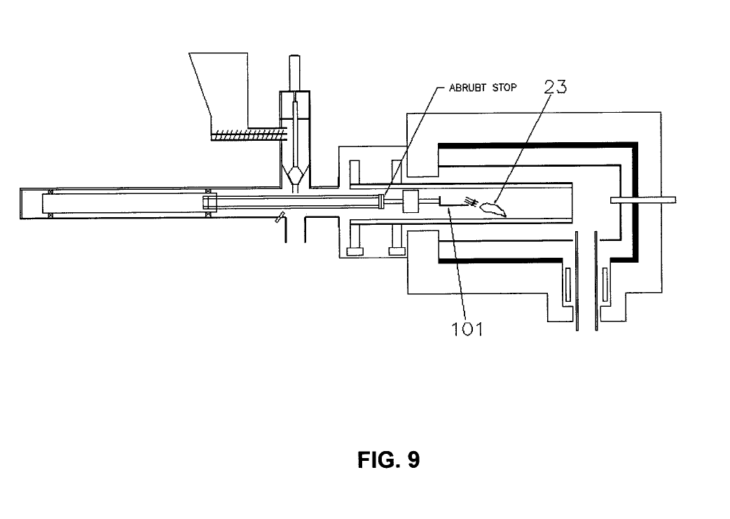

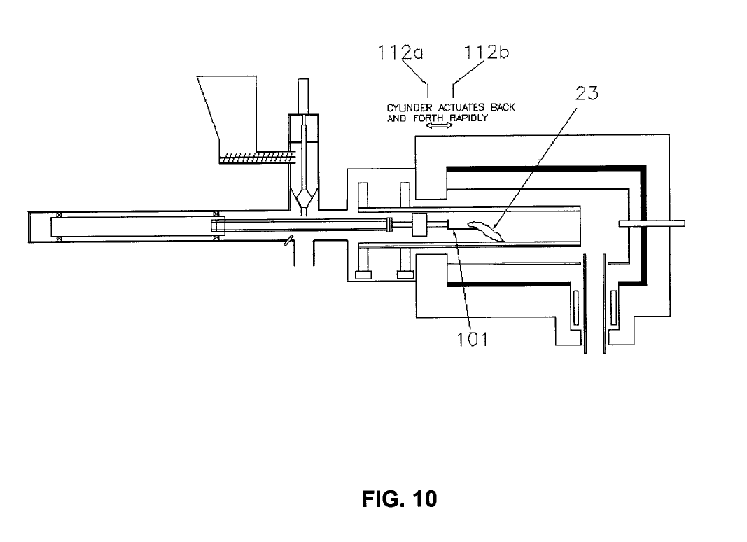

FIG. 9 shows a third embodiment. This embodiment is similar to the second embodiment. However, rather then pushing material 23 from shovel 101 with scrapper 106, actuator 42 is designed to move shovel 101 from position 55 to position 56 at such a rate of speed and to then abruptly stop shovel 101 when it reaches position 56, such that the momentum of material 23 and abrupt stop of shovel 101 results in material 23 sliding off the end of shovel 101 into process tube 2, as shown in FIG. 9. Moreover, as shown in FIG. 10, linear actuator 42 may be controlled to actuate rapidly back and forth between positions 112a and 112b to propel material 23 off of shovel 101 and into process tube 2 in heating chamber 4.

The present invention contemplates that many changes and modifications may be made. Therefore, while the presently-preferred form of the improved furnace has been shown and described, and a number of alternatives discussed, persons skilled in this art will readily appreciate that various additional changes and modifications may be made without departing from the spirit of the invention, as defined and differentiated by the following claims.

What is claimed is:

1. An automatic feed oven system for material processing comprising:
an insulated heating chamber;
said heating chamber having a product discharge outlet and a material inlet;
a heating source operatively arranged to heat said heating chamber;
a chamber feed mechanism operatively arranged to feed material into said chamber through said material inlet;
said chamber feed mechanism comprising:
a receptacle operatively arranged to receive material,
a linear actuator operatively arranged to move said receptacle between a fill position outside said chamber and a discharge position within said chamber, and
a rotational actuator operatively arranged to rotate said receptacle between a receiving position and a releasing position; and
a receptacle feed mechanism operatively arranged to feed material into said receptacle when said receptacle is in said fill position.

2. The oven set forth in claim 1, wherein said heating source is operatively arranged to selectively heat said heating chamber to at least 600 degrees Celsius.

3. The oven set forth in claim 1, wherein said heating chamber and said chamber feed mechanism are within an internal atmosphere isolated from an external ambient atmosphere.

4. The oven set forth in claim 1, wherein said fill position and said discharge position are at least two feet apart.

5. The oven set forth in claim 1, wherein said receiving position and said releasing position are between about 90 degrees and 180 degrees apart.

6. The oven set forth in claim 1, and further comprising a spill access port for removal of material spilled between said receptacle and said receptacle feed mechanism.

7. The oven set forth in claim 1, and further comprising a cooling apparatus configured to cool said receptacle.

8. The oven set forth in claim 1, wherein said receptacle feed mechanism comprises:
a screw or vibratory conveyor having an inlet and an outlet;
a hopper having an outlet in communication with said inlet of said screw or vibratory conveyor; and
said outlet of said screw or vibratory conveyor operatively configured to feed material into said receptacle when said receptacle is in said fill position.

9. The oven set forth in claim 8, wherein said receptacle feed mechanism comprises a metering control communicating with said conveyor and configured to activate said conveyor when said receptacle is in said fill position and to deactivate said conveyor when said receptacle is not in said fill position.

10. The oven set forth in claim 1, wherein said receptacle feed mechanism comprises:
a funnel having a discharge port; and
a stopper configured to move from an open position to a closed position;
wherein said discharge port is substantially blocked by said stopper when said stopper is in said closed position.

11. The oven set forth in claim 10, wherein said receptacle feed mechanism comprises a metering control configured to provide said stopper in said open position when said receptacle is in said fill position and to provide said stopper in said closed position when said receptacle is not in said fill position.

12. The oven set forth in claim 11, wherein said metering control comprises a mechanical trigger.

13. The oven set forth in claim 1, wherein said receptacle comprises a scrapper configured to dislodge said material from said receptacle when said receptacle is in said discharge position.

14. The oven set forth in claim 1, and further comprising:
a generally horizontally extending process tube supported for rotation relative to said heating chamber;
said process tube having a portion extending into said heating chamber; and
said feed mechanism configured and arranged to feed product into said process tube.

15. The oven set forth in claim 1, and further comprising:
a generally horizontally extending process tube supported for rotation relative to said heating chamber;
said process tube having a first portion generally arranged outside of said heating chamber and a cantilevered second portion extending from said first portion into said heating chamber and terminating in a discharge end within said heating chamber;
said feed mechanism configured and arranged to feed product into said process tube; and
a bearing assembly operating between a support member and said first portion of said process tube and configured and arranged to support said process tube and transmit rotational torque to said process tube.

16. The oven set forth in claim 1, wherein said heating chamber comprises:
an outer shell;
a muffle; and
an insulation layer between said outer shell and said muffle.

17. The oven set forth in claim 1, wherein said heating element is a graphite resistance heating element.

18. The oven set forth in claim 1, wherein said heating element comprises induction coils and a graphite susceptor.

19. The oven set forth in claim 1, wherein said heating element is an exothermic reaction within said heating chamber.

20. The oven set forth in claim 15, wherein said process tube is graphite or quartz.

21. The oven set forth in claim 15, wherein said chamber feed mechanism extends through said first portion of said process tube and terminates at said feed discharge position within said heating chamber.

22. The oven set forth in claim 1, wherein said product discharge outlet comprises a discharge chute and a discharge heating element operatively arranged to selectively heat said discharge chute.

23. An automatic feed oven system for material processing comprising:
an insulated heating chamber;
said heating chamber having a product discharge outlet and a material inlet;
a heating source operatively arranged to heat said heating chamber;
a chamber feed mechanism operatively arranged to feed material into said chamber through said material inlet;
said chamber feed mechanism comprising:
a receptacle operatively configured to receive material,
a linear actuator operatively arranged to move said receptacle between a fill position outside said chamber and a discharge position within said chamber, and
a scrapper operatively arranged to dislodge said material from said receptacle when said receptacle is in said discharge position; and
a receptacle feed mechanism operatively arranged to feed material into said receptacle when said receptacle is in said fill position.

24. The oven set forth in claim 23, wherein said scrapper comprises a linear actuator connected to a member operatively arranged to dislodge material from said receptacle.
